(19) United States
(12) Patent Application Publication
(10) Pub. No.: US 2026/0045837 A1
(43) Pub. Date: Feb. 12, 2026

(54) STATOR

(71) Applicant: KABUSHIKI KAISHA TOSHIBA, Tokyo (JP)

(72) Inventors: Yuki UCHINO, Yokohama (JP); Takahiro TOI, Yokohama (JP)

(73) Assignee: KABUSHIKI KAISHA TOSHIBA, Tokyo (JP)

(21) Appl. No.: 19/269,511

(22) Filed: Jul. 15, 2025

(30) Foreign Application Priority Data
Jul. 29, 2024 (JP) 2024-122385

(51) Int. Cl. H02K 1/16

(52) U.S. Cl. CPC H02K 1/16

(57) ABSTRACT

A stator according to a present embodiment includes a plurality of split iron cores constituting a stator iron core, and a multi-phase coil conductor inserted into slot portions of the stator iron core. The coil conductor is a continuous coil in which linear portions to be housed in the slot portions of the stator iron core and crossover portions each corresponding to a portion between adjacent two of the slot portions at coil end parts are alternately arranged. The stator is formed by inserting the coil conductor into the slot portions formed by arranging the plurality of split iron cores on a plane, and then shaping the split iron cores and the coil conductor into an annular shape.

### BACKGROUND OF THE INVENTION

### Field of the Invention

An embodiment of the present invention generally relates to a stator of a rotary electric machine.

### Description of the Related Art

To manufacture a stator of a rotary electric machine, a step in which a coil conductor of a rectangular wire shaped in a hairpin shape is inserted into a stator iron core, and welding is performed after coil ends are formed is generally often performed. Such a step takes a lot of time and effort and is low in workability. Various configurations and methods for more easily manufacturing a stator have been conventionally proposed in, for example, Japanese Patent No. 3,982,446 and Japanese Patent Laid-Open No. 2009-11116.

However, the methods and the configurations disclosed in the above-described patent literatures exclusively improve workability when a stator winding wire is disposed on a stator, but it cannot be said that the workability is sufficiently excellent.

### BRIEF DESCRIPTION OF THE DRAWINGS

FIG. 1(A), FIG. 1(B), and FIG. 1(C) are respectively an axial end surface view, a plan view, and a perspective view of a split iron core according to a first embodiment;

FIG. 2(A) is a perspective view illustrating a state immediately before a coupling pin is inserted into the split iron core, FIG. 2(B) is a perspective view illustrating a state where the coupling pin is inserted into the split iron core, and FIG. 2(C) is a perspective view illustrating a state immediately before another split iron core is coupled;

FIG. 3(A) and FIG. 3(B) are respectively a perspective view and a plan view illustrating a state where two split iron cores are coupled;

FIG. 4(A) is a perspective view illustrating a state where a plurality of split iron cores are coupled and developed in a linear shape, and FIG. 4(B) is an axial end surface view in a state where the state illustrated in FIG. 4(A) is upside down;

FIG. 5 is a perspective view illustrating a state immediately before a coil conductor in a linearly developed state is inserted into a stator iron core in a linearly developed state;

FIG. 6(A) is an axial end surface view illustrating an initial stage of shaping the stator iron core in the linearly developed state into an annular shape, and FIG. 6(B) is an axial end surface view illustrating the stator iron core

FIG. 7 is a diagram for explaining difference in characteristics based on presence/absence of chip portions in the stator iron core;

FIG. 8(A), FIG. 8(B), and FIG. 8(C) are respectively an axial end surface view, a plan view, and a perspective view of a split iron core according to a second embodiment;

FIG. 9(A) is a perspective view illustrating a state immediately before a coupling pin is inserted into the split iron core, FIG. 9(B) is a perspective view illustrating a State where the coupling pin is inserted into the split iron core, and FIG. 9(C) is a perspective view illustrating a state immediately before another split iron core is coupled;

FIG. 10(A) is a perspective view illustrating a state in a middle of coupling of two split iron cores, and FIG. 10(B) is a perspective view illustrating a state where the coupling is completed;

FIG. 11(A), FIG. 11(B), and FIG. 11(C) are respectively an axial end surface view, a plan view, and a perspective view of a split iron core according to a third embodiment ;

FIG. 12(A) is a perspective view illustrating a state immediately before a coupling pin is inserted into the split iron core, FIG. 12(B) is a perspective view illustrating a state where the coupling pin is inserted into the split iron core, and FIG. 12(C) is a perspective view illustrating a state immediately before another split iron core is coupled;

FIG. 13(A) is a perspective view illustrating a state in a middle of coupling of two split iron cores, and FIG. 13(B) is a perspective view illustrating a state where the coupling is completed;

FIG. 14(A) is an axial end surface view illustrating an initial stage of shaping a stator iron core in a linearly developed state into an annular shape, and FIG. 14(B) is an axial end surface view illustrating the stator iron core shaped in the annular shape;

FIG. 15(A), FIG. 15(B), and FIG. 15(C) are respectively an axial end surface view, a plan view, and a perspective view of a split iron core according to a fourth embodiment;

FIG. 16(A) is a perspective view illustrating a state where two split iron cores are disposed side by side in mutually opposite directions, and FIG. 16(B) and FIG. 16(C) are respectively a perspective view and a plan view illustrating a state where the two split iron cores are combined;

FIG. 17(A) is a perspective view illustrating a state immediately before a coupling pin is inserted into the split iron cores in the state illustrated in FIG. 16(C), FIG. 17(B) is a perspective view illustrating a state in a middle of insertion of the coupling pin, and FIG. 17(C) is a perspective view illustrating a state where the insertion is completed;

FIG. 18(A), FIG. 18(B), and FIG. 18(C) are respectively an axial end surface view, a plan view, and a perspective view of a split iron core according to a fifth embodiment;

FIG. 19(A) is a perspective view illustrating a state where two split iron cores are disposed side by side in the same direction, and FIG. 19(B) and FIG. 19(C) are respectively a perspective view and a plan view illustrating a state where the two split iron cores are combined;

FIG. 20(A) is a perspective view illustrating a state immediately before a coupling pin is inserted into the split iron cores in the state illustrated in FIG. 19(C), FIG. 20(B) is a perspective view illustrating a state in a middle of insertion of the coupling pin, and FIG. 20(C) is a perspective view illustrating a state where the insertion is completed;

FIG. 21(A) and FIG. 21(B) are respectively a plan view and an axial end surface view illustrating a state where a coil conductor in a linearly developed state is inserted into a stator iron core in a linearly developed state;

FIG. 22(A), FIG. 22(B), and FIG. 22(C) are respectively an axial end surface view, a plan view, and a perspective view of a split iron core according to a sixth embodiment;

FIG. 23(A) and FIG. 23(B) are respectively an axial end surface view and a perspective view of a jig, FIG. 23(C) is an axial end surface view illustrating a state where a plurality of jigs are arranged in a linear shape, and FIG. 23 (D) is an axial end surface view illustrating a state where split iron cores are disposed on the jigs illustrated in FIG. 23(C);

FIG. 24(A) is a perspective view corresponding to FIG. 23(C), and FIG. 24(B) is a perspective view corresponding to FIG. 23 (D);

FIG. 25(A), FIG. 25(B), and FIG. 25(C) are respectively an axial end surface view, a plan view, and a perspective view illustrating a state where an inner diameter holding jig and a handle are attached in the state illustrated in FIG. 23(D);

FIG. 26 is a first diagram illustrating a step of rotating the inner diameter holding jig and the handle in a counterclockwise direction to shape a stator iron core into an annular shape;

FIG. 27 is a second diagram illustrating the step of rotating the inner diameter holding jig and the handle in the counterclockwise direction to shape the stator iron core into the annular shape;

FIG. 28 is a third diagram illustrating the step of rotating the inner diameter holding jig and the handle in the counterclockwise direction to shape the stator iron core into the annular shape; and

FIG. 29 is a diagram illustrating a state where the stator iron core is completely shaped into the annular shape.

### DETAILED DESCRIPTION OF THE INVENTION

Therefore, there is provided a stator of a rotary electric machine that can be more easily manufactured.

A stator according to a present embodiment includes a plurality of split iron cores constituting a stator iron core, and a multi-phase coil conductor inserted into slot portions of the stator iron core. The coil conductor is a continuous coil in which linear portions to be housed in the slot portions of the stator iron core and crossover portions each corresponding to a portion between adjacent two of the slot portions at coil end parts are alternately arranged. The stator is formed by inserting the coil conductor into the slot portions formed by arranging the plurality of split iron cores on a plane, and then shaping the split iron cores and the coil conductor into an annular shape.

### First Embodiment

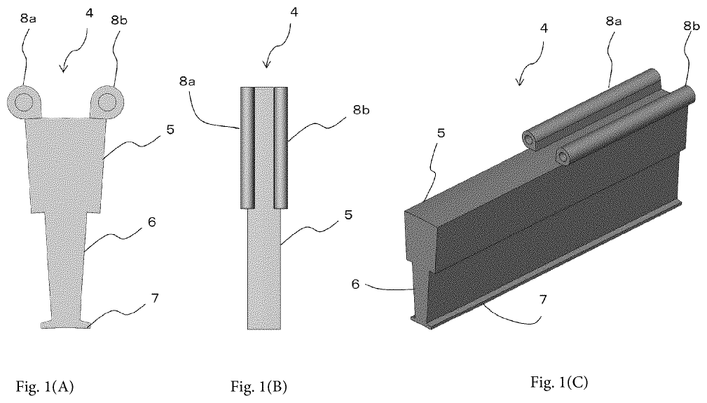

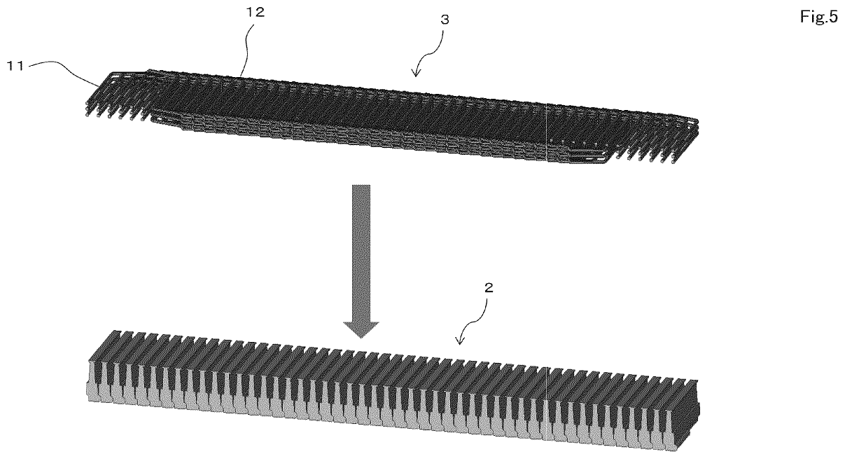

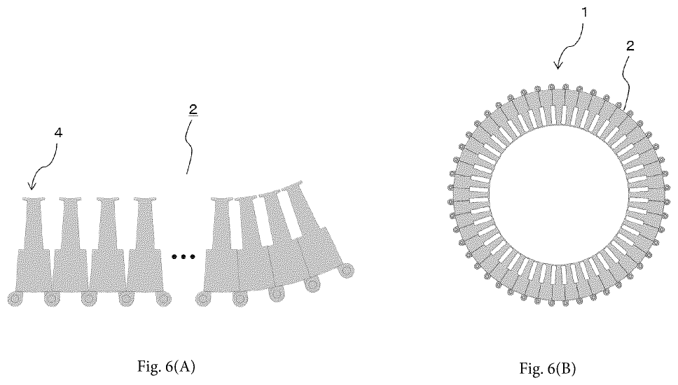

A first embodiment is described below with reference to FIG. 1(A) to 7. As illustrated in FIG. 5 to FIG. 6(B), a stator 1 of a rotary electric machine according to the present embodiment includes a stator iron core 2 and a coil conductor 3. The stator iron core 2 is configured by coupling a plurality of split iron cores 4 illustrated in FIG. 1(A) to 1(C). Each split iron core 4 includes a back yoke portion 5 that has a substantially trapezoidal cross-sectional shape, and a tooth portion 6 that extends from a center part of the back yoke portion 5 so as to be tapered toward an inner peripheral side. A chip portion 7 that has a short arc shape in a circumferential direction as a right-left direction in the drawing is provided at a front end of the tooth portion 6.

As illustrated in FIG. 1(A) to 1(C), cylindrical insertion holes 8a and 8b serving as coupling portions are provided on an outer peripheral side that is an upper side of the back yoke portion 5 in the drawing. An axial length of each of the insertion holes 8a and 8b is half an axial length of the back yoke portion 5, and the insertion holes 8a and 8b are disposed close to one end side of the back yoke portion 5.

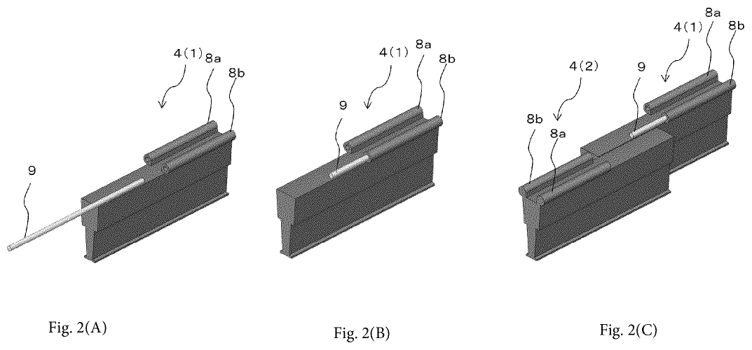

When two split iron cores 4(1) and 4(2) are coupled to each other, a coupling pin 9 is inserted into the insertion hole 8b of the split iron core 4(1) as illustrated in FIG. 2(A) to 2(C). An axial length of the coupling pin 9 is set equal to the length of the back yoke portion 5. In a state where the coupling pin 9 is inserted into the insertion hole 8b of the split iron core 4(1), half of the coupling pin 9 is exposed in an axial direction. After the insertion hole 8b of the split iron core 4(1) and the insertion hole 8b of the other split iron core 4(2) are caused to face each other in the axial direction such that a center of the insertion hole 8b of the other split iron core 4(2) is aligned to a center of the insertion hole 8b of the split iron core 4(1), the exposed coupling pin 9 is inserted into the insertion hole 8b of the split iron core 4(2).

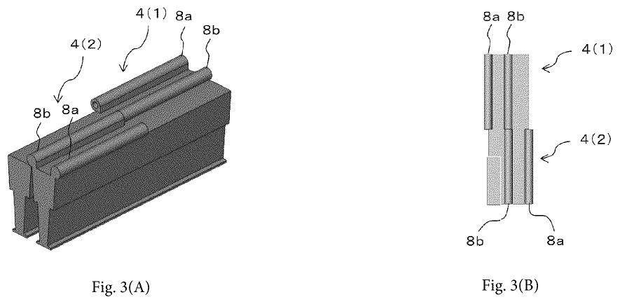

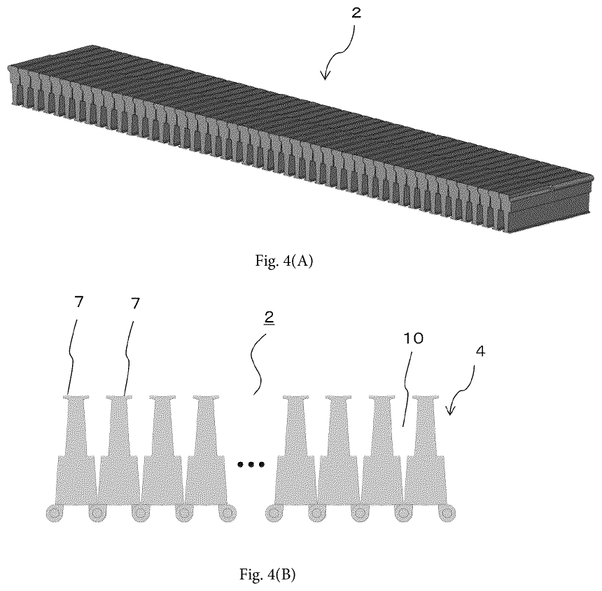

As a result, as illustrated in FIG. 3(A) to 3(B), the split iron cores 4(1) and 4(2) are coupled to each other through the insertion holes 8b and the coupling pin 9. Each of the insertion holes 8a is used to be similarly coupled to the insertion hole 8a of the split iron core 4 adjacently disposed. When the split iron cores 4 are sequentially coupled in the above-described manner, the stator iron core 2 is put into a linearly developed state as illustrated in FIG. 4(A) to 4(B). A slot portion 10 where the coil conductor 3 is to be disposed is formed between a tooth portion 6(1) of the split iron core 4(1) and a tooth portion 6(2) of the split iron core 4(2).

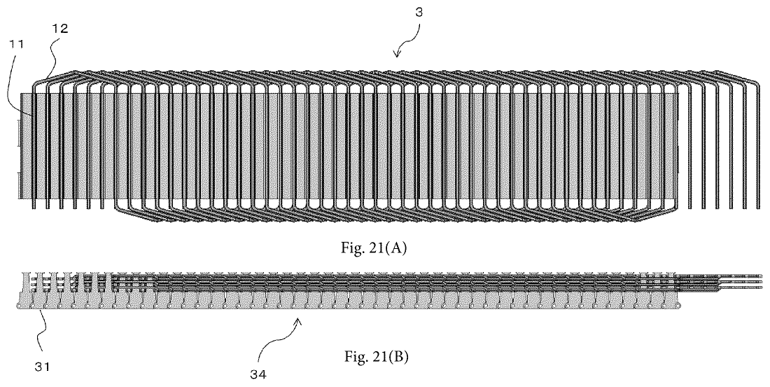

Next, a method of manufacturing the stator 1 is described. The stator iron core 2 in the linearly developed state as illustrated in FIG. 4(A) is disposed such that the tooth portions 6 are directed upward in the drawing as illustrated in FIG. 4(B). As illustrated in FIG. 5, the coil conductor 3 configured by a rectangular wire is a continuous coil in which linear portions 11 to be housed in the slot portions 10 of the stator iron core 2 and crossover portions 12 each corresponding to a portion between adjacent two of the slot portions 10 at coil end parts are alternately arranged. The three-phase coil conductor 3 is previously wave-wound and developed in a linear shape. The linear portions 11 of the coil conductor 3 are housed in the slot portions 10 of the stator iron core 2 linearly developed. A plan view and an axial end surface view of the housed state are illustrated in FIG. 21(A) to 21(B) according to a fifth embodiment described below. The linear portions 11 and the crossover portions 12 of the coil conductor 3 are also illustrated more clearly in FIG. 21(A) TO 21(B).

Thereafter, as illustrated in FIG. 6(A), one end of the stator iron core 2 is lifted upward by using a jig and the like, to integrally shape the stator iron core 2 and the coil conductor 3 into an arc shape. As illustrated in FIG. 6(B), two split iron cores 4 positioned at both ends of the stator iron core 2 are finally coupled through the coupling pin 9, to shape the stator iron core 2 into an annular shape. As a result, the stator 1 is completed. Note that illustration of the coil conductor 3 is omitted in FIG. 6(A) to 6(B).

At this time, in a case of an existing manufacturing step in which a coil conductor is inserted into a stator iron core previously shaped into an annular shape, it is difficult to form chip portions on an inner peripheral side of the stator iron core because the chip portions obstruct insertion of the coil conductor. In contrast, in the case of the stator 1 according to the present embodiment, the step in which the stator iron core 2 and the coil conductor 3 are previously developed together in a linear shape, and then, the stator iron core 2 is shaped into the annular shape is performed as described above. This makes it possible to enable easy formation of the chip portions 7 on the inner peripheral side of the stator iron core 2.

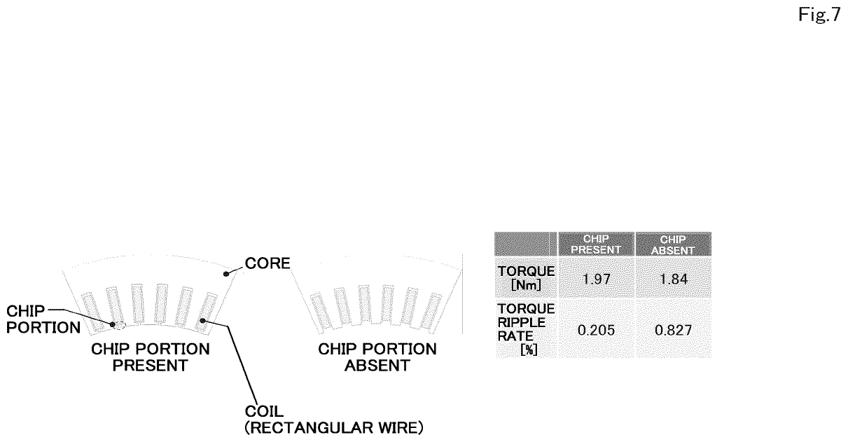

As illustrated in FIG. 7, torque and a torque ripple rate based on presence/absence of the chip portions were simulated in a rotary electric machine having a certain specification. A result that the torque is increased and the torque ripple rate is reduced when the chip portions are present was obtained from the simulation. Therefore, it is surmised that characteristics lowered due to the fact that the stator iron core 2 is configured by the plurality of split iron cores 4 can be sufficiently recovered.

As described above, according to the present embodiment, the stator 1 includes the plurality of split iron cores 4 constituting the stator iron core 2, and the multi-phase coil conductor 3 inserted into the slot portions 10 of the stator iron core 2. The coil conductor 3 is a continuous coil in which the linear portions 11 to be housed in the slot portions 10 and the crossover portions 12 each corresponding to a portion between adjacent two of the slot portions 10 at the coil end parts are alternately arranged. The stator 1 is completed by inserting the coil conductor 3 into the slot portions 10 formed by arranging the plurality of split iron cores 4 on a plane, and then shaping the split iron cores 4 and the coil conductor 3 into the annular shape. Therefore, it is possible to eliminate the existing troublesome manufacturing step in which the coil conductor is inserted into the stator iron core previously shaped in the annular shape, and to easily manufacture the stator 1.

### Second Embodiment

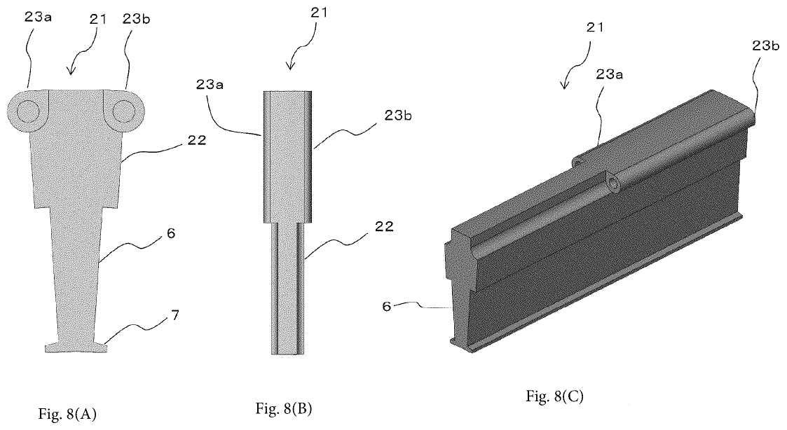

In the following, the same parts as in the first embodiment are denoted by the same reference numerals and description of the parts is omitted, and different parts are described. In the following embodiments, variations of the configuration of the split iron core are described. As illustrated in FIG. 8(A) to 8(C), a split iron core 21 according to a second embodiment includes a back yoke portion 22 as a substitute for the back yoke portion 5. In the split iron core 4 according to the first embodiment, the insertion holes 8 are disposed so as to protrude outward from an outer peripheral surface of the back yoke portion 5. In contrast, in the split iron core 21, insertion holes 23 are formed inside the back yoke portion 22.

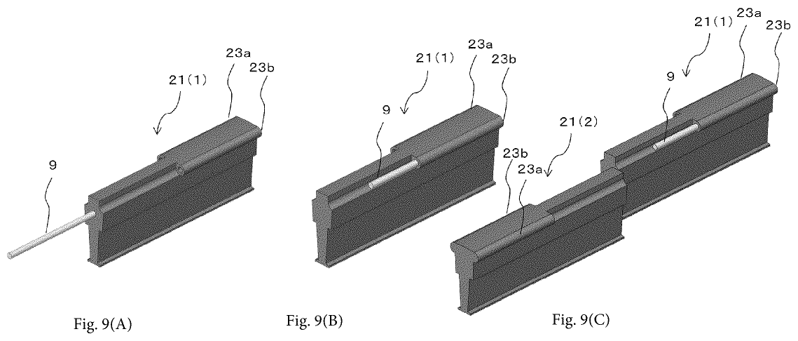

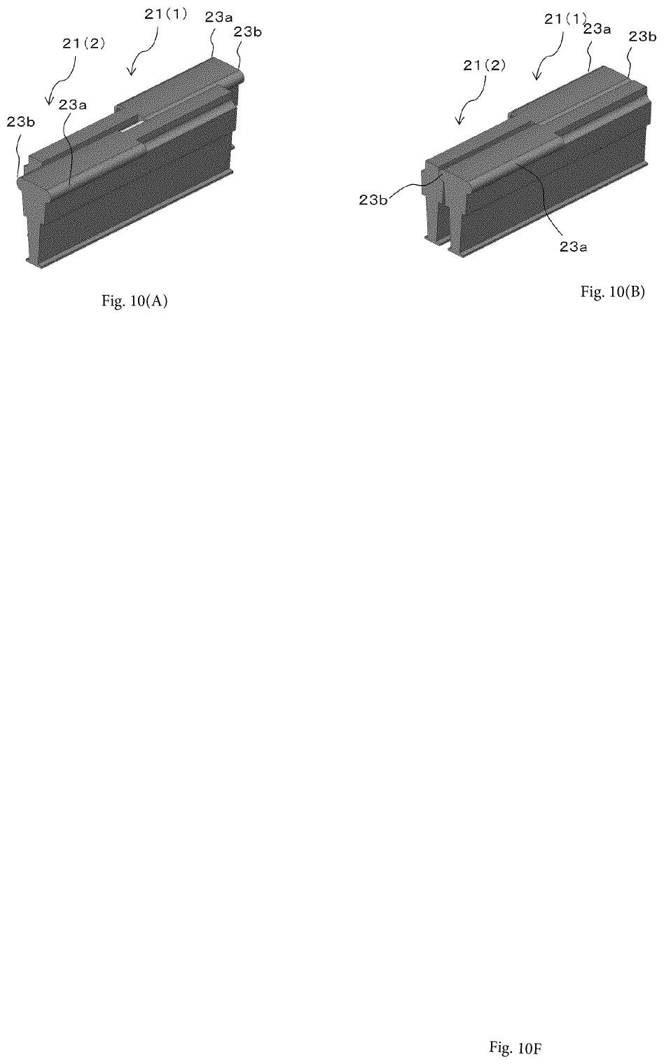

When two split iron cores 21(1) and 21(2) are coupled to each other, the coupling pin 9 is inserted into an insertion hole 23b of the split iron core 21(1) as illustrated in FIG. 9(A) TO 9(C) in a manner basically similar to the first embodiment. Then, after the insertion hole 23b of the split iron core 21(1) and an insertion hole 23b of the other split iron core 21(2) are caused to face each other in the axial direction such that a center of the insertion hole 23b of the other split iron core 21(2) is aligned to a center of the insertion hole 23b of the split iron core 21(1), the exposed coupling pin 9 is inserted into the insertion hole 23b of the split iron core 21(2). As illustrated in FIG. 10(A) and FIG. 10(B), the subsequent manufacturing step of coupling the split iron cores 21(1) and 21(2) is similar to the manufacturing step in the first embodiment.

### Third Embodiment

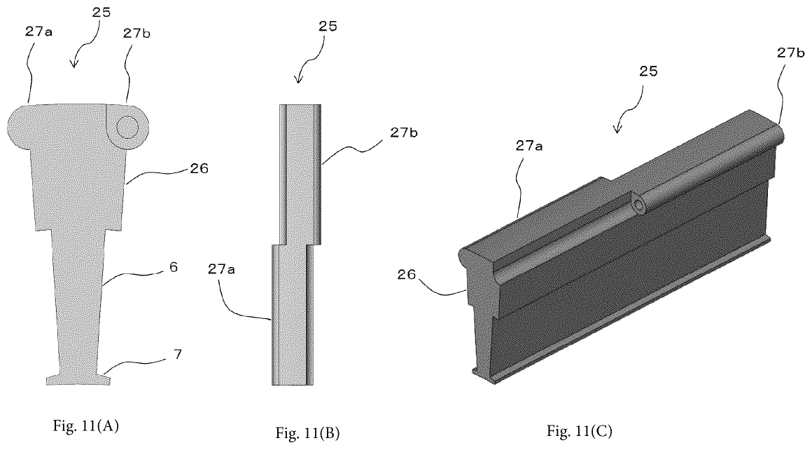

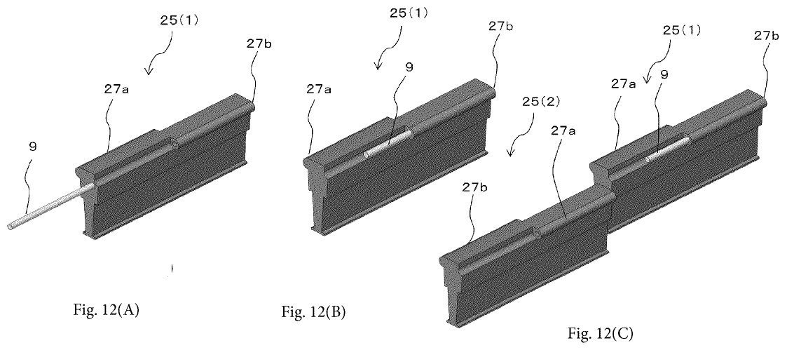

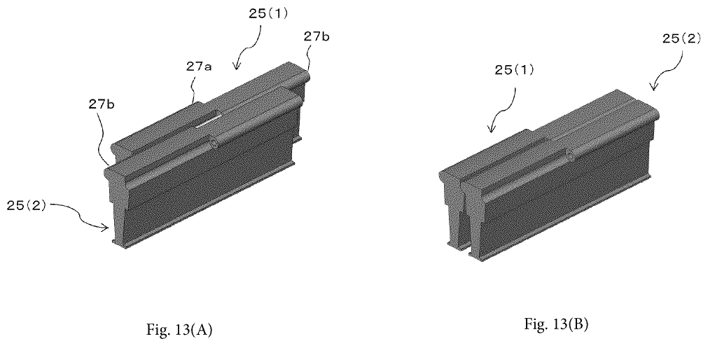

As illustrated in FIG. 11(A) TO 11(C), a split iron core 25 according to a third embodiment includes a back yoke portion 26 as a substitute for the back yoke portion 22 of the split iron core 21, and insertion holes 27a and 27b are provided in the back yoke portion 26. The insertion hole 27b has a configuration substantially same as the configuration of the insertion hole 23b of the split iron core 21. As illustrated in FIG. 11(B), the insertion hole 27a as a substitute for the insertion hole 23a is provided in positional relationship of point symmetrical to the insertion hole 27b. Two split iron cores 25(1) and 25(2) are coupled as illustrated in FIG. 12(A) to 12(C) and FIG. 13(A) to 13(B) in a manner basically similar to the second embodiment by replacing the insertion hole 23b with the insertion hole 27b.

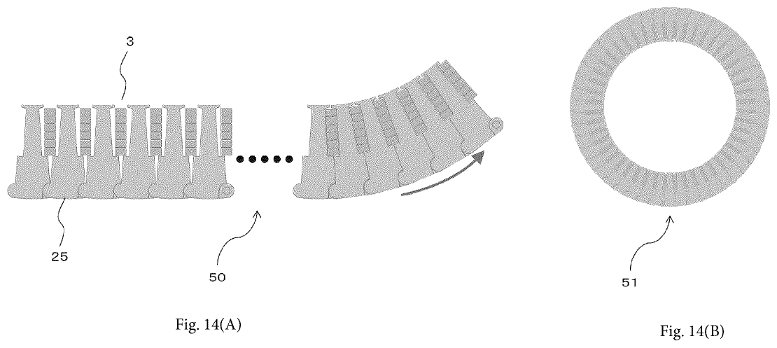

FIG. 14(A) illustrates a step in which the coil conductor developed in the linear shape is inserted into a stator iron core 50 that is obtained by coupling a plurality of split iron cores 25 and is developed in the linear shape, and one end of the stator iron core 50 is lifted upward to integrally shape the stator iron core 50 and the coil conductor 3 into the arc shape. As illustrated in FIG. 14(B), two split iron cores 25 positioned at both ends of the stator iron core 50 are finally coupled through the coupling pin 9, to shape the stator iron core 50 in the annular shape. As a result, a stator 51 is completed.

### Fourth Embodiment

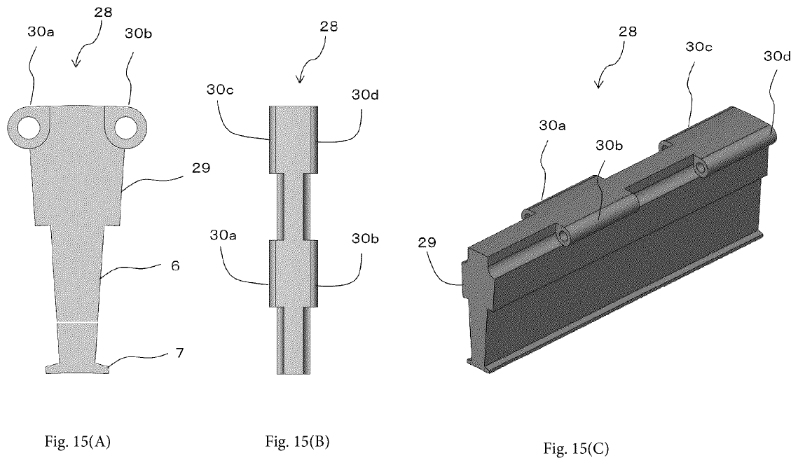

As illustrated in FIG. 15(A) TO 15(C), a split iron core 28 according to a fourth embodiment includes a back yoke portion 29 as a substitute for the back yoke portion 22 of the split iron core 21, and four insertion holes 30a to 30d are provided in the back yoke portion 29. An axial length of each insertion hole 30 is set to ¼ of a length of the back yoke portion 29. The insertion holes 30a and 30c are concentrically provided, and the insertion holes 30b and 30d are

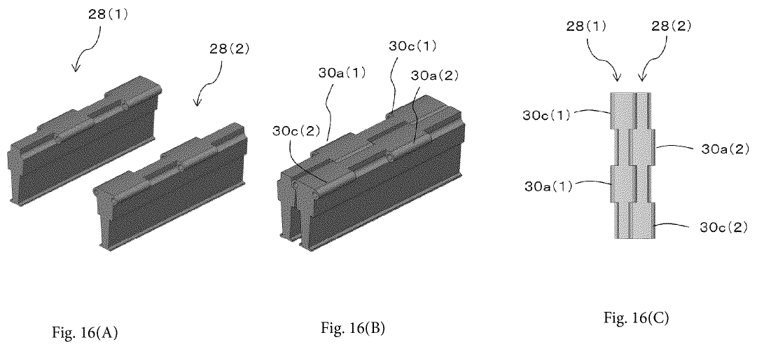

When two split iron cores 28(1) and 28(2) are coupled to each other, the split iron core 28(2) is directed in an opposite direction and disposed beside the split iron core 28(1) as illustrated in FIG. 16(A), and the split iron cores 28(1) and 28(2) are then caused to engage with each other as illustrated in FIG. 16(B) and 16(C). In other words, the split iron cores 28(1) and 28(2) are disposed such that the insertion hole 30b of the split iron core 28(1) is positioned between the insertion holes 30b and 30d of the split iron core 28(2), and the insertion hole 30d of the split iron core 28(1) communicates with the insertion hole 30b of the split iron core 28(2).

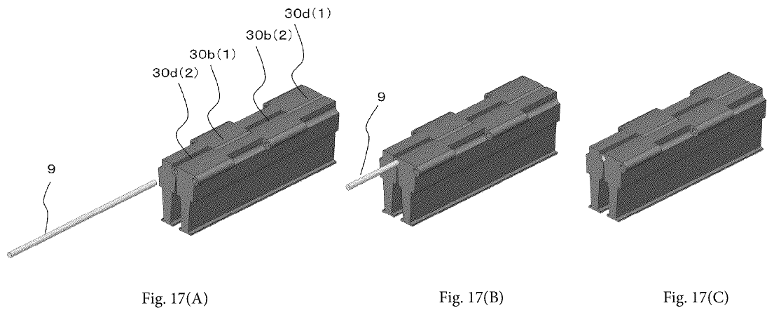

As illustrated in FIG. 17(A), when the split iron cores 28(1) and 28(2) are caused to engage with each other, insertion holes 30d(2), 30b(1), 30b(2), and 30d(1) communicate with each other. Thereafter, the coupling pin 9 is inserted from the insertion hole 30d(2) to pass through the insertion holes 30b(1), 30b(2), and 30d(1), thereby coupling the split iron cores 28(1) and 28(2) as illustrated in FIG. 17(B) and 17(C).

### Fifth Embodiment

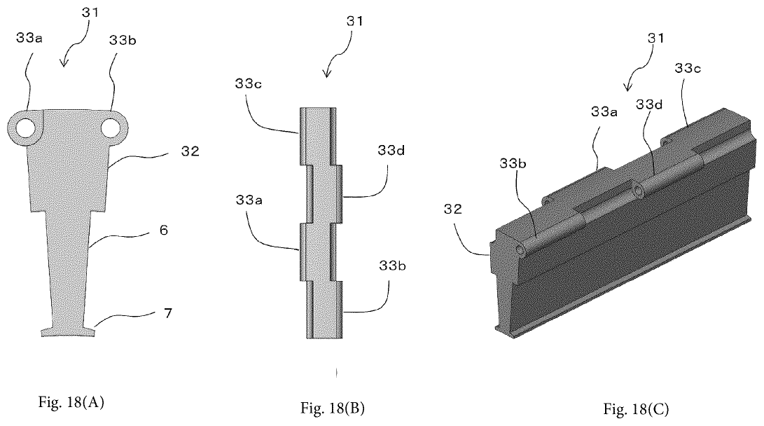

As illustrated in FIG. 18(A) to 18(C), a split iron core 31 according to a fifth embodiment includes a back yoke portion 32 as a substitute for the back yoke portion 22 of the split iron core 21, and four insertion holes 33a to 33d are provided in the back yoke portion 32. An axial length of each insertion hole 33 is set to ¼ of a length of the back yoke portion 32. The insertion holes 33a and 33c are concentrically provided, and the insertion holes 33b and 33d are concentrically provided.

As illustrated in FIG. 18(B) that is a plan view on an outer peripheral surface side, the insertion hole 33c is disposed on an upper left side, the insertion hole 33d is successively disposed on a right side, the insertion hole 33a is successively disposed on a left side, and the insertion hole 33b is successively disposed on a lower right side. In other words, the insertion holes 33c, 33d, 33a, and 33b are alternately provided in a right-left direction from the upper left side to the lower right side, and the four insertion holes 33c, 33d, 33a, and 33b are point-symmetrically arranged.

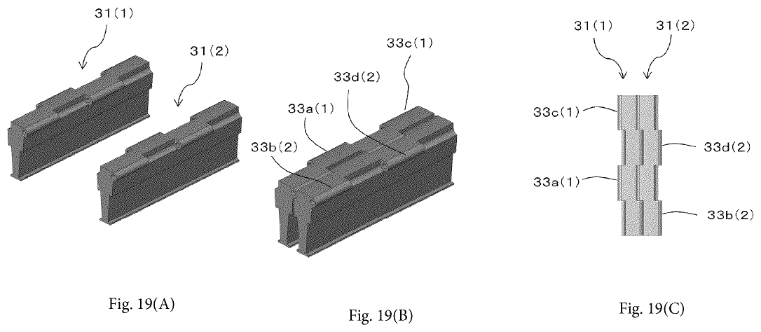

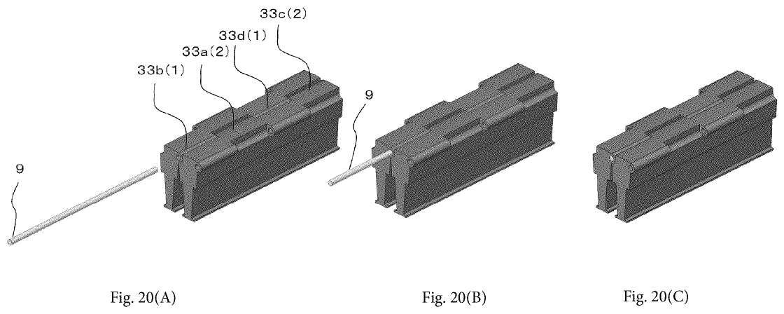

When two split iron cores 31(1) and 31(2) are coupled to each other, the split iron cores 31(1) and 31(2) are disposed side by side in the same direction as illustrated in FIG. 19(A), and are caused to engage each other as illustrated in FIG. 19(B) and 19(C). As a result, as illustrated in FIG. 20(A) to 20(C), the insertion hole 33b of the split iron core 31(1), the insertion hole 33a of the split iron core 31(2), the insertion hole 33d of the split iron core 31(1), and the insertion hole 33c of the split iron core 31(2) communicate with each other. Thereafter, the coupling pin 9 is inserted from the insertion hole 33b(1) to pass through the insertion holes 33a(2), 33d(1), and 33c(2) as illustrated in FIG. 20(B) and 20(C).

FIG. 21(A) and 21(B) are respectively a plan view and an axial end surface view illustrating a state where the coil conductor 3 developed in the linear shape is inserted into a stator iron core 34 that is obtained by coupling a plurality of split iron cores 31 and is developed in the linear shape. According to the fifth embodiment having the above-described configuration, when the two split iron cores 31(1) and 31(2) are coupled to each other, it is unnecessary to dispose the two split iron cores 31(1) and 31(2) in mutually opposite directions unlike the split iron cores 28 according to the fourth embodiment. Thus, the stator iron core can be more easily assembled.

### Sixth Embodiment

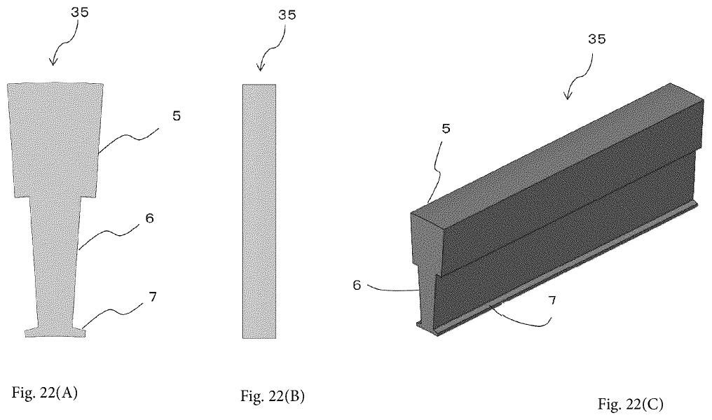

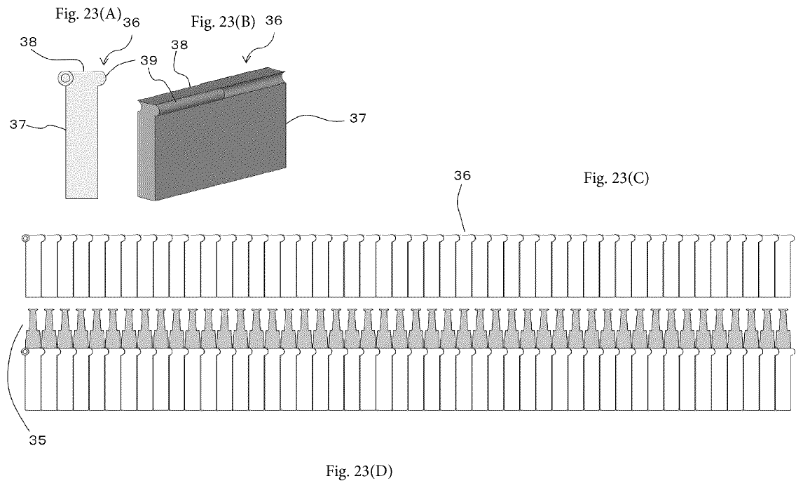

As illustrated in FIG. 22(A) to 22(C), a split iron core 35 according to a sixth embodiment is obtained by removing the insertion holes 8 from the split iron core 4 according to the first embodiment, and has no coupling portion. To shape such split iron cores 35 in an annular shape, jigs 36 illustrated in FIG. 23(A) to 23(D) are used. FIG. 23(A) and 23(B) are respectively an axial end surface view and a perspective view illustrating one jig 36. Each of the jigs 36 includes a rectangular parallelepiped base portion 37, and an engagement portion 38 positioned on the base portion 37 in the drawings.

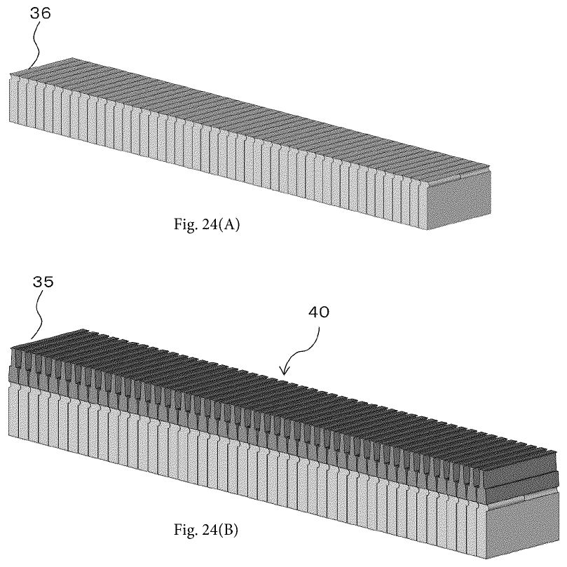

As illustrated in FIG. 23(A), a shape of each of the jigs 36 is a substantially T-shape as viewed from the axial end surface, and a convex portion 39 is provided on a right part of the engagement portion 38 in the drawings. FIG. 23(C) illustrates a state where the plurality of jigs 36 are caused to engage with each other through the engagement portions 38 and arranged in the linear shape. FIG. 23(D) illustrates a state where the split iron cores 35 are disposed on the jigs 36 arranged in the linear shape in one-to-one correspondence. FIG. 24(A) and FIG. 24(B) are respectively perspective views of the states illustrated in FIG. 23(C) and FIG. 23(D). In FIG. 23(D) and FIG. 24(B), a stator iron core 40 in which the split iron cores 35 are not coupled to each other but are developed in the linear shape is disposed on the jigs 36 arranged in the linear shape.

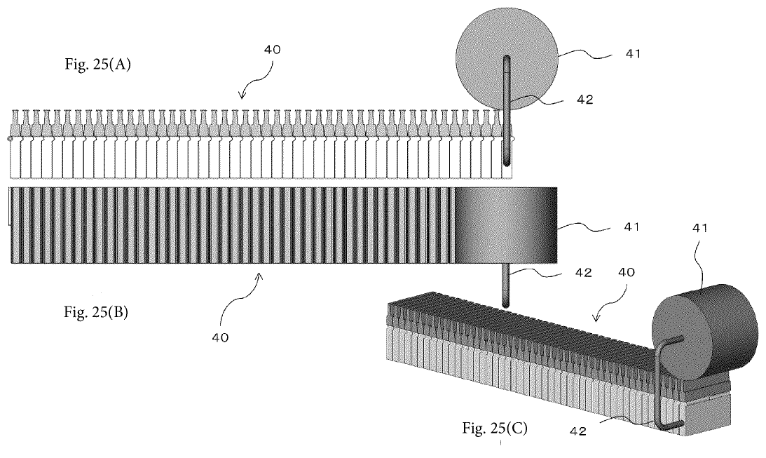

A step of shaping the stator iron core 40 into the annular shape is described below. Note that illustration of the coil conductor 3 is omitted. As illustrated in FIG. 25(A), a cylindrical inner diameter holding jig 41 is placed on the split iron core 35 of the stator iron core 40 positioned at a right end in the drawing. A diameter of the inner diameter holding jig 41 is equal to an inner diameter of the stator iron core 40 shaped in the annular shape. Further, as illustrated in FIG. 25(B), an axial length of the inner diameter holding jig 41 is equal to an axial length of the stator iron core 40.

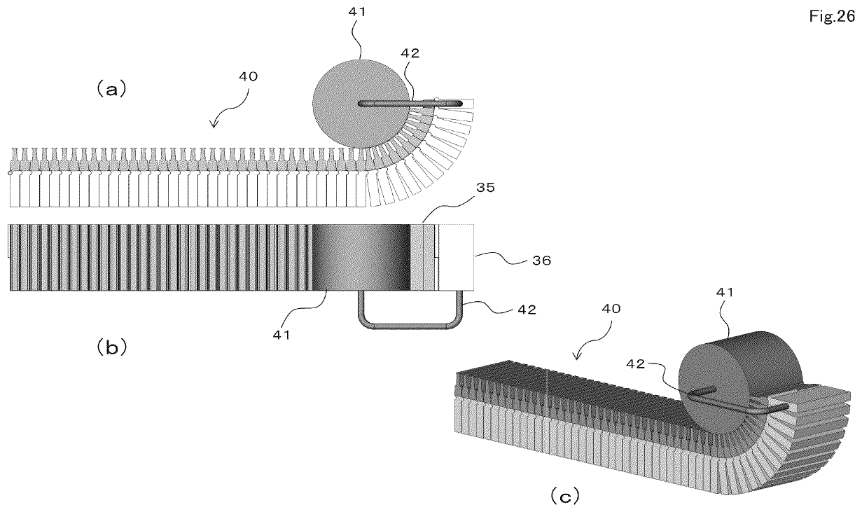

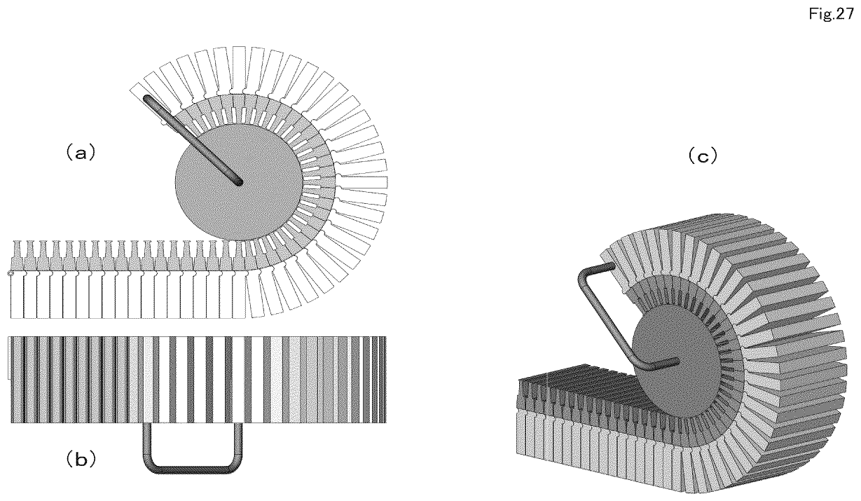

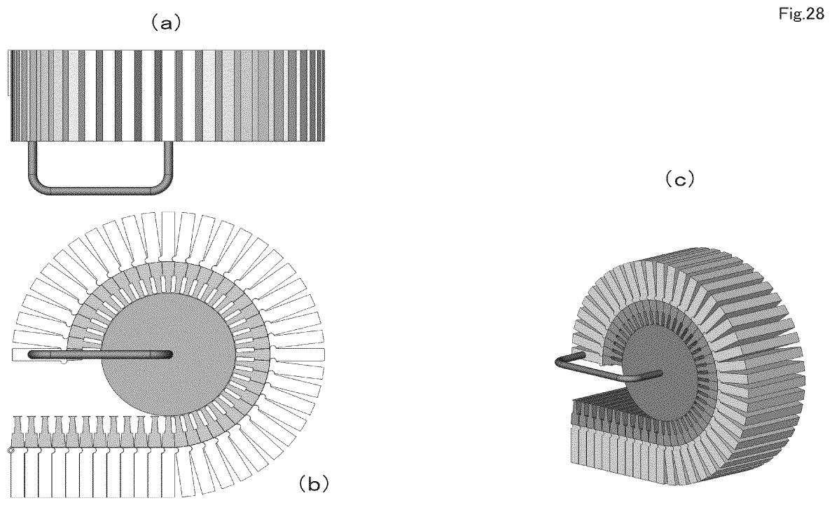

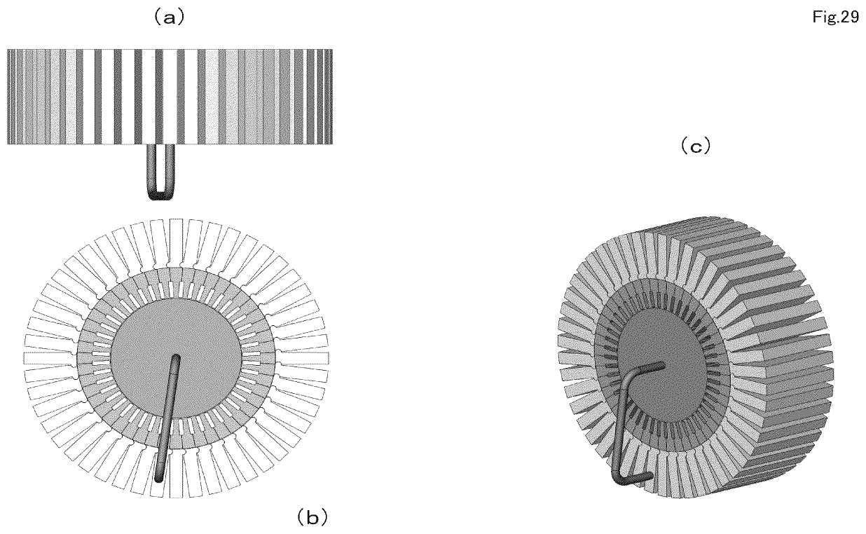

An insertion hole into which a corresponding end part of a U-shaped handle 42 is inserted is formed at a center part of the inner diameter holding jig 41 and a base portion 37 of the split iron core 35 of the stator iron core 40 positioned at the right end. The end parts of the handle 42 are inserted into the respective insertion holes to stabilize the inner diameter holding jig 41. From the state, as illustrated in FIG. 26 to FIG. 28, the handle 42 on the split iron core 35 side is lifted up and is rotated together with the inner diameter holding jig 41 in a counterclockwise direction. As illustrated in FIG. 29, both ends of the stator iron core 40 finally come into contact with each other, and the stator iron core 40 is shaped in the annular shape.

### Other Embodiments

The chip portions 7 are formed as necessary.

Specific configurations of the coupling portions are not limited to the illustrated configurations.

The coil conductor is not limited to the wave-wound coil conductor as long as the coil conductor is a continuous coil.

For example, the axial length of each insertion hole 8 according to the first embodiment may be less than ½ of the axial length of the back yoke portion 5.

Further, the axial length of each insertion hole 30 according to the fourth embodiment may be less than ¼ of the axial length of the back yoke portion 29.

Although some embodiments of the present invention are described above, these embodiments are presented as examples, and do not intend to limit the scope of the invention. These novel embodiments can be implemented in various other forms, and various omissions, substitutions, and changes can be made without departing from the spirit of the invention. These embodiments and modifications are included in the scope and the spirit of the invention, and are included in the invention described in the claims and the equivalent scope thereof.

1. A stator, comprising:
a plurality of split ion cores constituting a stator iron core; and
a multi-phase coil conductor configured to be inserted into slot portions of the stator iron core, wherein
the coil conductor is a continuous coil in which linear portions to be housed in the slot portions of the stator iron core and crossover portions each corresponding to a portion between adjacent two of the slot portions at coil end parts are alternately arranged, and
the stator is formed by inserting the coil conductor into the slot portions formed by arranging the plurality of split iron cores on a plane, and then shaping the split iron cores and the coil conductor into an annular shape.

2. The stator according to claim 1, wherein, in each of the split iron cores, a cross-section including a tooth portion extending from a back yoke portion to an inner diameter side has a substantially T-shape.

3. The stator according to claim 2, wherein a chip portion having a shape extending in a circumferential direction is provided at a front end of the tooth portion.

4. The stator according to claim 2, wherein the back yoke portion of each of the split iron cores includes a coupling portion to be coupled to the back yoke portion of an adjacent split iron core.

5. The stator according to claim 4, wherein
the coupling portion includes an insertion hole disposed along an axial direction and having a length of ½ or less of an axial length of the back yoke portion, and
in a state where centers of the insertion holes of the adjacent split iron cores are aligned in the axial direction, coupling is performed by inserting a coupling pin into the insertion holes.

6. The stator according to claim 5, wherein
the coupling portion includes insertion holes each having a length of ¼ or less of the axial length of the back yoke portion, and
the insertion holes are disposed two by two on one side and another side of the back yoke portion in a circumferential direction in a point-symmetrical positional relationship.

7. The stator according to claim 1, wherein the coil conductor has a rectangular cross-section.

8. The stator according to claim 3, wherein the back yoke portion of each of the split iron cores includes a coupling portion to be coupled to the back yoke portion of an adjacent split iron core.
